(19) United States
(12) Patent Application Publication
(10) Pub. No.: US 2021/0208477 A1
(43) Pub. Date: Jul. 8, 2021

(54) CAMERA FILTER, PHOTOGRAPHING DEVICE, AND HANDHELD DEVICE

(71) Applicant: SZ DJI TECHNOLOGY CO., LTD., Shenzhen (CN)

(72) Inventor: Tianhang MA, Shenzhen (CN)

(21) Appl. No.: 17/209,170

(22) Filed: Mar. 22, 2021

Related U.S. Application Data
(63) Continuation of application No. PCT/CN2018/119487, filed on Dec. 6, 2018.

(30) Foreign Application Priority Data
Sep. 29, 2018 (CN) 201821612172.4

(51) Int. Cl. G03B 11/00; G03B 17/12

(52) U.S. Cl. CPC G03B 11/00; G03B 17/12

(57) ABSTRACT

A camera filter includes a lens frame, a lens, and an adsorption member. The lens is mounted at the lens frame and covers the lens hole. The adsorption member is made of a magnetic material and surrounds the lens hole.

### CROSS-REFERENCE TO RELATED APPLICATIONS

This application is a continuation of International Application No. PCT/CN2018/119487, filed Dec. 6, 2018, which claims priority to Chinese Application No. 201821612172.4, filed Sep. 29, 2018, the entire contents of both of which are incorporated herein by reference.

### TECHNICAL FIELD

The present disclosure relates to the technical field of photography and, more particularly, to a camera filter, photographing device, and handheld device.

### BACKGROUND

Photographing devices, such as cameras, use the optical imaging principle to form and record images. When a photographing device shoots an object, light reflected by the object passes through a lens assembly and irradiates a photosensitive element to generate an electrical signal. The photographing device forms corresponding image information from the electrical signal.

In order to improve and adjust the light obtained by the photographing device, different filters are attached to the lens assembly for different shooting effects. Such filters include ultraviolet (UV) filter, skylight filter, neutral density (ND) filter, or polarizer.

In related technology, the filter is mounted to the lens assembly through a screw structure. However, a mounting space is small in photographing devices like a small handheld gimbal, mounting of a filter through a screw structure at the handheld gimbal is difficult and may damage the gimbal. Moreover, when the shape of the filter is non-circular, the assembly and alignment are more difficult.

### SUMMARY

In accordance with the disclosure, there is provided a camera filter including a lens frame, a lens, and an adsorption member. The lens is mounted at the lens frame and covers the lens hole. The adsorption member is made of a magnetic material and surrounds the lens hole.

Also in accordance with the disclosure, there is provided a photographing device including a photographing apparatus and a camera filter. The camera filter includes a lens frame having a lens hole, a lens fixed at the lens frame and covering the lens hole, and an adsorption member surrounding the lens hole. The adsorption member is made of a magnetic material. The camera filter is magnetically connected to the photographing apparatus via the adsorption member.

Also in accordance with the disclosure, there is provided a handheld device including a handheld member and a photographing device. The photographing device includes a photographing apparatus and a camera filter. The camera filter includes a lens frame having a lens hole, a lens fixed at the lens frame and covering the lens hole, and an adsorption member surrounding the lens hole. The adsorption member is made of a magnetic material. The camera filter is magnetically connected to the photographing apparatus via the adsorption member. The handheld member includes a controller electrically coupled to the photographing device and configured to control the photographing device to perform a photographing function.

### BRIEF DESCRIPTION OF THE DRAWINGS

FIG. 1 is a schematic structural diagram of a camera filter from a first angle according to an example embodiment.

FIG. 2 is a schematic structural diagram of a camera filter from a second angle according to an example embodiment.

FIG. 3 is a schematic cross-sectional view of a camera filter with a lens frame according to an example embodiment.

FIG. 4 is a schematic cross-sectional view of a camera filter with another lens frame according to an example embodiment.

FIG. 5 is a schematic cross-sectional view of a camera filter with an elastic member according to an example embodiment.

FIG. 6 is a schematic cross-sectional view of a lens according to an example embodiment.

FIG. 7 is a schematic cross-sectional view showing a camera filter mounted at a photographing apparatus according to an example embodiment.

FIG. 8 is a schematic view showing a camera filter mounted at a photographing apparatus according to an example embodiment.

FIG. 9 is a schematic structural diagram of a handheld device according to an example embodiment.

FIG. 10 is a schematic rear view of a handheld device according to an example embodiment.

### REFERENCE NUMERALS

lens frame 10; lens hole 11; mounting member 12; connection member 13; main body 14; marking member 15; lens 20; light-transmission body 21; protective film 22; light-transmission member 23; adsorption member 30; elastic member 31; camera filter 100; photographing apparatus 200; shooting hole 201; casing 202; lens assembly 203; magnetic member 204; protection member 205; handheld member 300; screen 301; shutter button 302; power button 303; hot shoe slot 304; gimbal 400.

### DETAILED DESCRIPTION OF THE EMBODIMENTS

Example embodiments will be described with reference to the accompanying drawings, in which the same numbers refer to the same or similar elements unless otherwise specified. The described embodiments are some rather than all of the embodiments of the present disclosure.

As described herein, terms used in the specification of the present disclosure are intended to describe example embodiments, instead of limiting the present disclosure. The singular forms “a,” “an,” and “the” used in the present disclosure and the appended claims are intended to include plural forms as well, unless the context clearly indicates otherwise. The term “and/or” used herein includes any suitable combination of one or more related items listed.

Although the terms first, second, third, etc. may be used in the present disclosure to describe various information, the information should not be limited to these terms. These terms are only used to distinguish the same type of information from each other. For example, within the scope of present disclosure, the first information may also be referred to as second information, and vice versa. Depending on the context, the word “if” as used herein can be interpreted as “when,” “while,” or “in response to determining.”

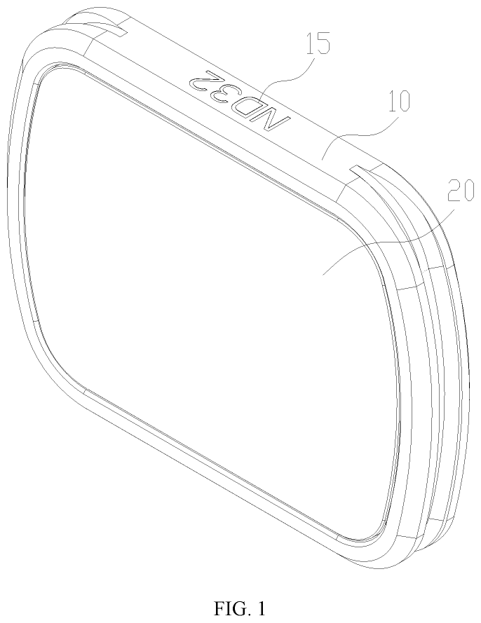

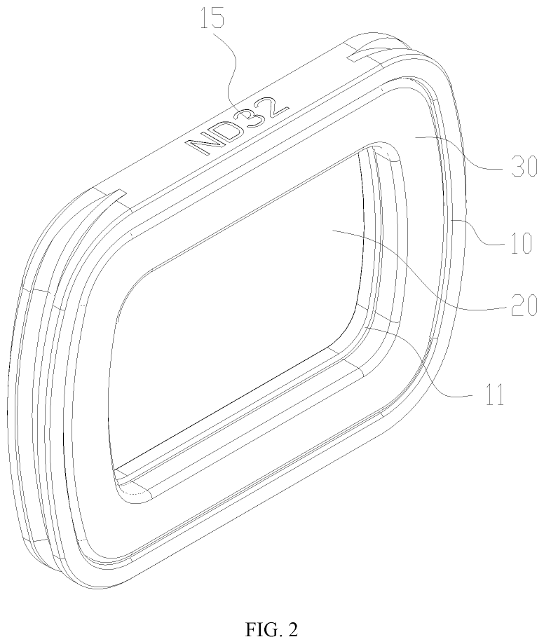

As shown in FIG. 1 and FIG. 2, in some embodiments, a camera filter 100 includes a lens frame 10, and a lens 20 and an adsorption member 30 fixed at the lens frame 10. The lens frame 10 is provided with a lens hole 11. The lens 20 covers the lens hole 11, and the adsorption member 30 surrounds the lens hole 11. The adsorption member 30 can be made of a magnetic material.

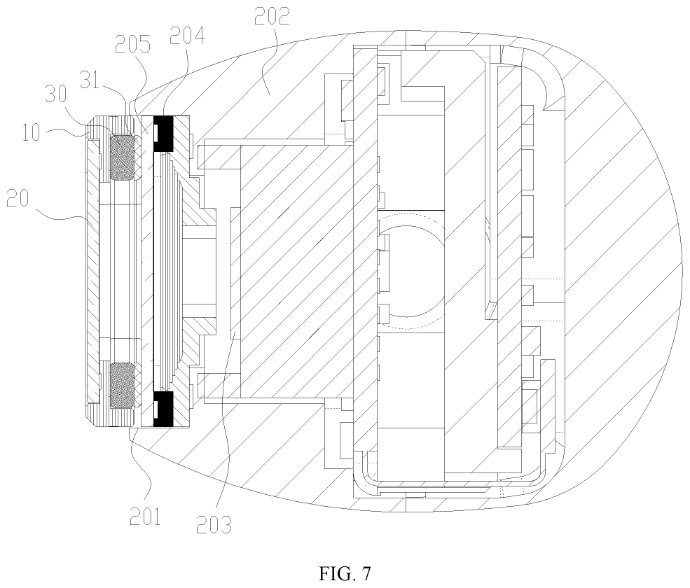

Because the adsorption member 30 can be made of a magnetic material, when the adsorption member 30 is close to an apparatus made of a magnetic or ferromagnetic material, the camera filter 100 can be magnetically connected to the apparatus via the adsorption member 30. As shown in FIG. 7, a photographing apparatus 200 includes a casing 202 that can be made of a ferromagnetic material. The adsorption member 30 can be adsorbed to the casing 202. The lens 20 covers the lens assembly 203, and a direction of an optical axis of the lens 20 can be approximately same as a direction of an optical axis of the lens assembly 203. Light from a shooting object can pass through the lens 20 and enter the lens assembly 203.

The camera filter 100 is provided with the adsorption member 30 made of the magnetic material, and hence camera filter 100 may be mounted to the photographing apparatus 200 by a form of magnetic connection. The mounting of the camera filter 100 is convenient. The camera filter 100 and the photographing apparatus 200 are magnetically connected to each other. The two only need to be provided with magnetically connecting portions, and do not need to employ a screw-fit connection structure, which is convenient to process. By magnetically connecting the camera filter 100 to the photographing apparatus 200, the profile of the camera filter 100 is less limited. For example, the camera filter 100 can be rectangular, circular, elliptical, etc.

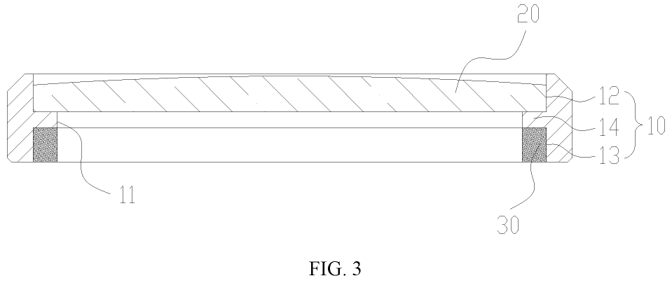

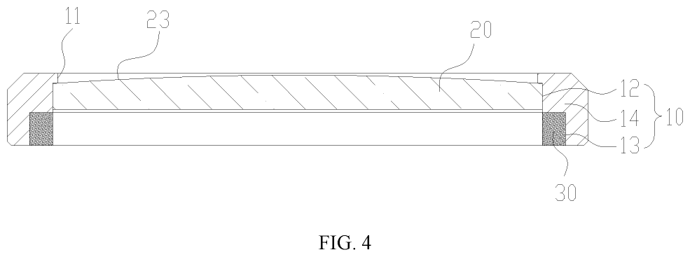

As shown in FIG. 3 and FIG. 4, the lens 20 is mounted at the lens frame 10 and covers the lens hole 11 so that light can transmit through the lens 20 and the lens hole 11. The adsorption member 30 surrounds the lens hole 11 and has little influence on the light transmission. The lens 20 and the adsorption member 30 can be mounted at the lens frame 10 with the same or different directions.

When the lens 20 and the adsorption member 30 are mounted at the lens frame 10 with different directions, the lens 20 can be mounted to the lens frame 10 from a first direction and the adsorption member 30 can be mounted to the lens frame 10 from a second direction opposite to the first direction. In some embodiments, the lens 20 is mounted at one side of the lens frame 10 and covers the lens hole 11, while the adsorption member 30 is mounted at another side of the lens frame 10 and is set apart from the lens 20. The lens 20 and the adsorption member 30 are independently mounted to the lens frame 10 and do not interfere with each other, which makes it easy to adjust positions thereof.

In some embodiments, the lens frame 10 includes a main body 14, and a mounting member 12 and a connection member 13 recessed from a surface of the main body 14. The lens 20 is mounted to the mounting member 12 and the adsorption member 30 is mounted to the connection member 13.

In some embodiments, the lens 20 and the adsorption member 30 are mounted at the lens frame 10 with different directions, and the mounting member 12 and the connection member 13 are arranged at two sides of the main body 14. The lens frame 10 is a loop structure with a “convex” cross section.

In some embodiments, the lens 20 and the adsorption member 30 are mounted at the lens frame 10 with the same direction, and the mounting member 12 and the connection member 13 are arranged at an inner side of the main body 14 in a stepped manner. The lens frame 10 is a loop structure with a stepped cross section.

With the mounting member 12 and the connection member 13, the lens 20 and the adsorption member 30 can be mounted and positioned more easily with a high positioning accuracy. The lens frame 10 is an integral part with the mounting member 12 and the connection member 13, which can provide support for the lens frame 10 and increase the strength of the lens frame 10. The lens frame 10 has a good structural stability and a high strength.

In some embodiments, the mounting member 12 is a groove structure in the lens frame 10, and the lens 20 can be easily mounted to the mounting member 12 using glue, interference fit, buckle connection, etc. It is convenient to mount the lens 20, and the lens 20 can provide support to a side wall of the mounting member 12 and enhance the strength of the lens frame 10.

The adsorption member 30 is used to magnetically connect the camera filter 100 to the photographing apparatus 200. The structure and distribution of the adsorption member 30 can facilitate the connection. For example, the adsorption member 30 can be an integral member or include distributed dots.

In some embodiments, the adsorption member 30 is an integral member fixed at the lens frame 10. The adsorption member 30 can have a loop shape and surround the lens hole 11. The adsorption member 30 can be made of a loop-shaped material as a whole. The structure of the adsorption member 30 can match the shape of the lens frame 10. If the lens frame 10 has a circular loop structure, the adsorption member 30 can be configured to have a circular loop shape and be fixed at the side wall of the lens frame 10. If the lens frame 10 has a rectangular loop structure, the adsorption member 30 can be correspondingly configured to have a rectangular loop shape. The lens hole 11 can be in communication with a space surrounded by the adsorption member 30.

In some embodiments, the adsorption member 30 includes distributed dots fixed at the lens frame 10. The adsorption member 30 can include one magnetic member at the lens frame 10 or a plurality of magnetic members distributed at the lens frame 10 with intervals. The adsorption member 30 can be configured to have a columnar or block structure, and the connection member 13 has a groove or hole structure at the lens frame 10. The adsorption member 30 can be mounted to the connection member 13 using insertion, glue, interference fit connection, etc. It is convenient to mount the adsorption member 30.

In some embodiments, the adsorption member 30 can be configured to have a rectangular structure, with its four sides being provided with the counterbore-shaped connection member 13. Each connection member 13 is provided with a magnetic member, so that the adsorption member 30 can be uniformly adsorbed to the corresponding photographing apparatus 200 with a strong connection. For example, the adsorption member 30 can be configured to conform to the shape and structural distribution of the lens frame 10. For example, the adsorption member 30 can be mounted to an uneven surface of the lens frames 10. The mounting is flexible.

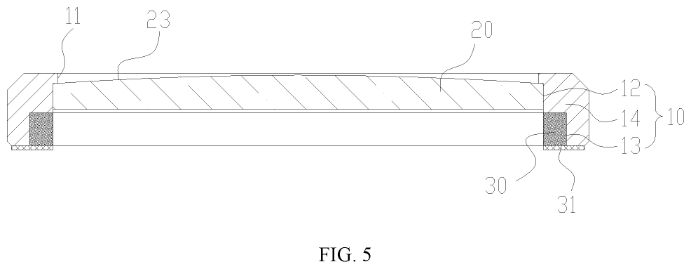

As shown in FIG. 5 and FIG. 7, the camera filter 100 further includes an elastic member 31 fixed at the adsorption member 30 and/or the lens frame 10, with at least a portion of the elastic member protruding out of the lens frame 10. In some embodiments, the elastic member 31 made of a soft material is mounted at one side of the adsorption member 30. In some embodiments, the elastic member 31 is provided at the lens frame 10. When the camera filter 100 is connected to the photographing apparatus 200, the elastic member 31 can further protect the photographing apparatus from damages such as scratches caused by the adsorption member 30 or the lens frame 10.

In some embodiments, the elastic member 31 is made of suitable soft material, such as silica gel or rubber, that is coated or glued on the surface of the adsorption member 30. When the camera filter 100 is connected to the photographing apparatus 200, the elastic member 31 has some elastic deformation so that the camera filter 100 and the photographing apparatus 200 are tightly sealed and fit with each other.

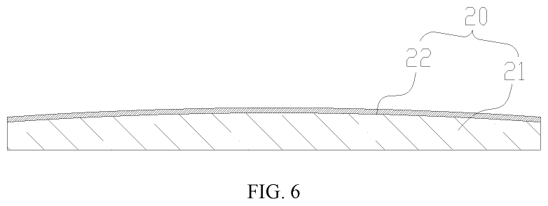

As shown in FIG. 4 and FIG. 6, in some embodiments, the lens 20 is made of a non-opaque material such as glass or synthetic resin. The lens 20 includes a light-transmission member 23 configured to change a transmission angle of light passing through the lens 20. The light-transmission member 23 is provided at a surface of the lens 20. Adjusting the shape of the light-transmission member 23 can change the transmission path of light passing through the light-transmission member 23, which can achieve certain shooting effect. For example, filters that has a lens 20 with a light-transmission member 23 include but are not limited to polygon lens, multi-row lens, fisheye lens, wide-angle lens, or other lens attachment.

In some embodiments, the lens 20 includes a light-transmission body 21 and a protective film 22 adhered to a surface of the light-transmission body 21 and configured to filter out the light in a preset frequency band. Light in other frequency bands is transmitted through the light-transmission body 21.

The light-transmission body 21 can be made of a non-opaque material such as glass or synthetic resin. The protective film 22 is made of a non-opaque material and is adhered to the surface of the light-transmission body 21. Light irradiates a surface of the protective film 22 from one side. The protective film 22 reflects the light in some frequency bands and transmits the light in other frequency bands to the other side of the protective film 22, such that the lens assembly 203 can receive the transmitted light only and the corresponding image information is formed with good effect. For example, the camera filter 100 includes at least one of a neutral density filter, an ultraviolet filter, or a polarizer.

Take the polarizer as an example for illustration. The polarizer is prepared by gluing a polyvinyl alcohol film processed by iodine dip dyeing between two pieces of flat optical glass. It allows a pass rate of about 80% for polarized light with the same polarization direction as the polarizer and only less than 1% for polarized light with a polarization direction perpendicular to that of the polarizer. After the polarizer is mounted to the lens assembly 203, the lens assembly 203 can obtain the corresponding polarized light and image information.

As shown in FIG. 1 and FIG. 2, when the camera filter 100 is mounted to, e.g., a photographing device, the model of the camera filter 100 and mounting direction need to be identified easily. In some embodiments, a marking member 15 with graphic and/or text mark is included at a side of the main body 14, more specifically, at an outer side of the main body 14. For example, the marking member 15 is at the side or a surface side of the main body 14, and this side faces outwards when the camera filter 100 is mounted to the photographing apparatus 200.

The mark in the marking member 15 may be a convex texture which is convex to the surface of the main body 14, or a concave texture which is recessed from the main body 14, or a graphic or text mark formed within recessed part from the main body 14.

The shape of the lens frame 10 can be adjusted according to the matching photographing apparatus 200. It can have a loop structure with, e.g., a rectangular, circular, or elliptical shape. In some embodiments, the lens frame 10 has a rectangular structure, with the intersection of the two adjacent sides being connected by an arc chamfer transition. The lens frame 10 is rectangular, so the lens 20 is accordingly configured as rectangular lens to be mounted to the lens frame 10. The lens frame 10 has four rectangular sides, with the intersection of the two adjacent sides being connected by an arc chamfer transition. The transition is smooth and the mounting is convenient for the lens frame 10.

In some embodiments, the marking member 15 is included at one of the rectangular sides, and this side should be put upwards in the photographing apparatus 200 when the camera filter 100 is mounted to the photographing apparatus 200.

As shown in FIG. 7, the camera filter 100 described above can be applied to the photographing device to adjust and improve the image information captured by the photographing apparatus 200. In some embodiments, the photographing device includes the photographing apparatus 200 and the camera filter 100 described above, where the camera filter 100 is magnetically connected to the photographing apparatus 200 via the adsorption member 30.

The camera filter 100 is adsorbed to the photographing apparatus 200 through the magnetic connection. The photographing apparatus 200 includes a part made of magnetic or ferromagnetic material that is corresponding to the adsorption member 30. As such, damage to the strength of the photographing apparatus 200 is reduced. The camera filter 100 is magnetically adsorbed to the photographing apparatus 200. The connection of the two is convenient, and the efficiency of replacing the camera filter 100 is high.

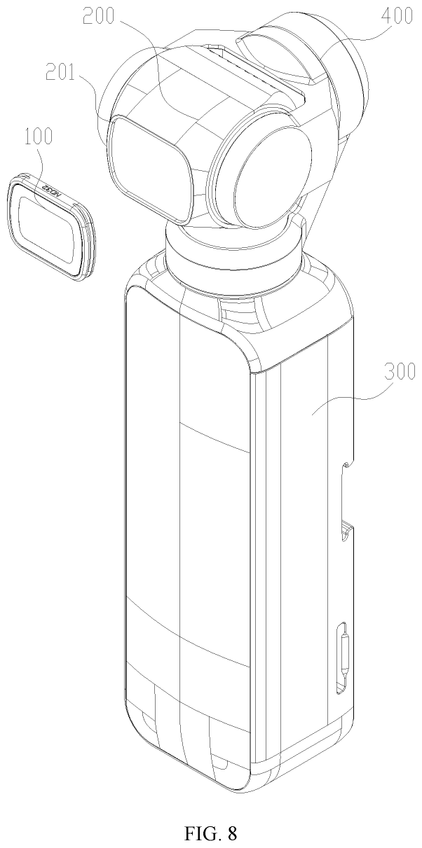

As shown in FIG. 7 and FIG. 8, in some embodiments, the photographing apparatus 200 includes a casing 202 and a lens assembly 203 arranged in the casing 202. The camera filter 100 is mounted at the casing 202, and a central axis of the camera filter 100 is approximately coincident with a central axis of the lens assembly 203. The lens assembly 203 is used to receive the light reflected by the shooting object and generate corresponding image information. The camera filter 100 is mounted at the casing 202 and covers the lens assembly 203. Light reflected by the shooting object enters the lens assembly 203 after being filtered by the camera filter 100, which changes the transmission path of some light, or absorb or reflect part of the light is absorbed or reflected. Corresponding image information is generated by the lens assembly 203 accordingly. Photographing quality is high and user experience is good.

In some embodiments, at least part of the casing 202 close to or in contact with the camera filter 100 is made of magnetic or ferromagnetic material such as iron, cobalt, or nickel. The camera filter 100 is directly attached to the casing 202 and the mounting is convenient.

In some embodiments, the casing 202 has a shooting hole 201 and at least a portion of the camera filter 100 is inserted in the shooting hole 201. The lens assembly 203 that is mounted at the casing 202 aligns with the shooting hole 201. In some embodiments, the central axis of the shooting hole 201 is coincident with the central axis of the lens assembly 203. The camera filter 100 is inserted in the shooting hole 201. Correspondingly, the camera filter 100, includes a plug-connection member that matches the shooting hole 201. In some embodiments, the plug-connection member is provided at the lens frame 10.

In some embodiments, the shooting hole 201 has a rectangular shape and the camera filter 100 is inserted in the shooting hole 201. The outer wall of the lens frame 10 matches the inner wall of the rectangular hole, so that the camera filter 100 can be clamped in the shooting hole 201 and the positioning accuracy is high. The central axis of the lens 20 and the central axis of the lens assembly 203 are highly coincident with each other.

In some embodiments, the casing 202 has a magnetic member 204 that surrounds the shooting hole 201. The magnetic member 204 can include a loop structure or local convex structures provided spaced apart at the casing 202, and can be magnetically connected to the adsorption member 30. In some embodiments, the magnetic member 204 is made of a magnetic or ferromagnetic material and is fixed or formed at the casing 202, such as a fastener made of steel material, an iron block or a magnet formed at the casing 202.

In some embodiments, the photographing apparatus 200 further includes a protection member 205 made of non-opaque material such as glass or synthetic resin. The protection member 205 is fixed to the casing 202 and covers the shooting hole 201. The lens assembly 203 faces the protection member 205.

In some embodiments, the protection member 205 is fixed to the casing 202 and covers the magnetic member 204 and the lens assembly 203 inside of the casing 202.

In some embodiments, the magnetic member 204 is provided at the inner wall of the casing 202 as a loop structure. The protection member 205 is attached to the magnetic member 204, such that the protection member 205 covers at the space formed by the magnetic member 204.

In some embodiments, the photographing apparatus 200 also includes a light shield attached to the casing 202. The light shield is mounted in the shooting hole 201, and a center hole of the light shield is aligned with the central axis of the lens assembly 203. The magnetic member 204 is fixed to the light shield, and the protection member 205 that is connected to the casing 202 covers the light shield to enclose the light shield inside the casing 202.

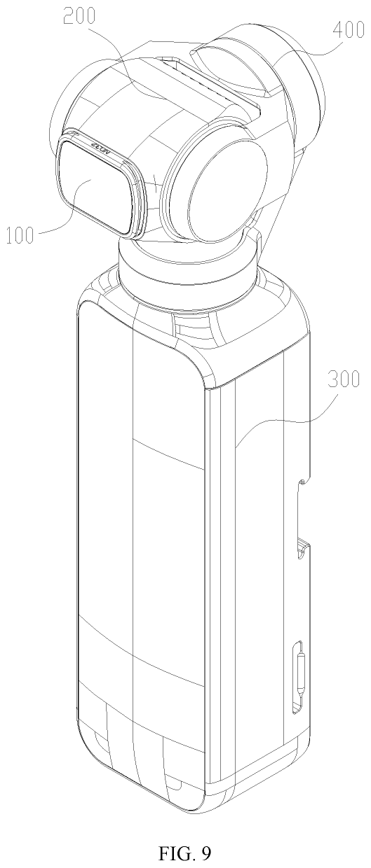

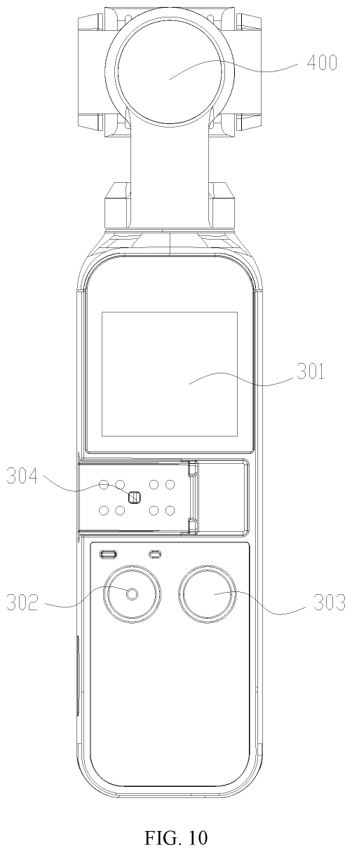

As shown in FIG. 8 to FIG. 10, the photographing device described above can be applied to a handheld device, which increases the application area and the flexibility of using the photographing device. In some embodiments, the handheld device includes a handheld member 300 and the photographing device described above. The handheld member 300 is equipped with a controller. The controller is electrically coupled to the photographing device and controls the photographing device to perform a photographing function.

The photographing device moves with the handheld member 300 and can be controlled by the controller of the handheld member 300 to perform the photographing function, which is easy to operate. The handheld member 300 can enlarge the shooting range and the shooting angle of the photographing device, with good user experience.

In some embodiments, the controller includes at least one of the following components: a screen 301, a microphone, a shutter button 302, a power button 303, and an LED indicator. With various buttons and corresponding indicative controls provided at the handheld member 300, users can control and know about the data from the photographing device in real time, and user experience is good.

For example, with the shutter button 302 provided at the handheld member 300, users can shoot corresponding object by pressing that button and obtain corresponding image information. With the power button 303 provided at the handheld member 300, the photographing device can be conveniently turned on and kept activated. With the screen 301 provided at the handheld member 300, the images captured by the photographing device can be observed in time and data can be transferred with other communication devices.

In some embodiments, the handheld member 300 further includes at least one of the following interfaces: a SD card slot, a charging hole, and a hot shoe slot 304. Providing various interfaces at the handheld member 300 can facilitate the data transfer and power supplement. For example, the SD card slot can be inserted with an SD memory card to store the image information in the SD memory card. The charging hole which is connected to an external power supply can charge and discharge the photographing device. The hot shoe slot 304 is used to connect with the mobile phone charging back clip for signal transmission and charging, which is convenient for information transmission.

In some embodiments, the handheld member 300 further includes a gimbal 400. The photographing device is mounted at the gimbal 400 and the controller is electrically coupled to the gimbal 400. The photographing device is mounted at the gimbal 400, so that the gimbal 400 can drive the photographing device to rotate to obtain a suitable shooting angle within a wide shooting range. The controller controls the movement of the gimbal 400 to cause the lens assembly 203 of the photographing device to face the direction of the shooting object, or the operation direction. For example, the gimbal 400 can be a one-axis gimbal or a multi-axis gimbal.

The photographing device including the camera filter 100 and the photographing apparatus 200 that are magnetically connected with each other can be applied to other mobile platforms such as an unmanned aerial vehicle or a gimbal of an unmanned aerial vehicle, which make the photographing convenient.

In the case of no conflict, the embodiments mentioned above and the features in the embodiments can be combined with each other. It is intended that the specification and examples be considered as example only and not to limit the present disclosure. Any modification, equivalent replacement, improvement, etc. made within the spirit and principle of the present disclosure shall be within the present disclosure.

What is claimed is:

1. A camera filter comprising:
a lens frame having a lens hole;
a lens fixed at the lens frame and covering the lens hole; and
an adsorption member surrounding the lens hole, the adsorption member being made of a magnetic material.

2. The camera filter of claim 1, wherein:
the lens is mounted at one side of the lens frame and covers the lens hole; and
the adsorption member is mounted at another side of the lens frame and is spaced apart from the lens.

3. The camera filter of claim 1, wherein:
the adsorption member has a loop-shaped structure and surrounds the lens hole; or
the adsorption member includes a plurality of magnetic members distributed at the lens frame with intervals.

4. The camera filter of claim 1, wherein the camera filter further includes an elastic member mounted at the adsorption member and/or the lens frame, at least a portion of the elastic member protruding out of the lens frame.

5. The camera filter of claim 1, wherein:
the lens frame includes a main body, and a mounting member and a connection member recessed from surface of the main body;
the lens is mounted at the mounting member; and
the adsorption member is mounted at the connection member.

6. The camera filter of claim 5, wherein the main body includes a marking member at a side of the main body, the marking member including graphic and/or text mark.

7. A photographing device comprising:
a photographing apparatus; and
a camera filter including:
a lens frame having a lens hole;
a lens fixed at the lens frame and covering the lens hole; and
an adsorption member surrounding the lens hole, the adsorption member being made of a magnetic material;
wherein the camera filter is magnetically connected to the photographing apparatus via the adsorption member.

8. The photographing device of claim 7, wherein:
the photographing apparatus includes a casing and a lens assembly arranged in the casing;
the camera filter is mounted at the casing; and
a central axis of the camera filter approximately coincides with a central axis of the lens assembly.

9. The photographing device of claim 8, wherein:
the casing has a shooting hole; and
at least a portion of the camera filter is inserted in the shooting hole.

10. A handheld device comprising:
a handheld member including a controller; and
a photographing device including:
a photographing apparatus; and
a camera filter including:
a lens frame having a lens hole;
a lens fixed at the lens frame and covering the lens hole; and
an adsorption member surrounding the lens hole, the adsorption member being made of a magnetic material;
wherein:
the camera filter is magnetically connected to the photographing apparatus via the adsorption member; and
the controller is electrically coupled to the photographing device and configured to control the photographing device to perform a photographing function.

11. The handheld device of claim 10, wherein:
the lens is mounted at one side of the lens frame and covers the lens hole; and
the adsorption member is mounted at another side of the lens frame and is spaced apart from the lens.

12. The handheld device of claim 10, wherein:
the adsorption member has a loop-shaped structure and surrounds the lens hole; or
the adsorption member includes a plurality of magnetic members distributed at the lens frame with intervals.

13. The handheld device of claim 10, wherein the camera filter further includes an elastic member mounted at the adsorption member and/or the lens frame, at least a portion of the elastic member protruding out of the lens frame.

14. The handheld device of claim 10, wherein:
the lens is made of a non-opaque material; and
the lens includes a light-transmission member configured to change a transmission angle of light passing through the lens.

15. The handheld device of claim 10, wherein the lens includes:
a light-transmission body; and
a protective film adhered to a surface of the light-transmission body and configured to filter out light in a preset frequency band.

16. The handheld device of claim 10, wherein:
the lens frame includes a main body, and a mounting member and a connection member recessed from surface of the main body;
the lens is mounted at the mounting member; and
the adsorption member is mounted at the connection member.

17. The handheld device of claim 16, wherein the main body includes a marking member at a side of the main body, the marking member including graphic and/or text mark.

18. The handheld device of claim 16, wherein the lens frame is rectangular, two adjacent sides of the lens frame being connected to each other by an arc chamfer transition.

19. The handheld device of claim 10, wherein:
the photographing apparatus includes a casing and a lens assembly arranged in the casing;
the camera filter is mounted at the casing; and
a central axis of the camera filter approximately coincides with a central axis of the lens assembly.

20. The handheld device of claim 10, wherein:
the photographing apparatus includes a casing that has a shooting hole, at least a portion of the camera filter being inserted in the shooting hole;
the controller includes at least one of the following components: a screen, a microphone, a shutter button, a power button, and an LED indicator; or
the handheld member further includes a gimbal, the photographing device being mounted at the gimbal and the controller being electrically coupled to the gimbal.
